(19) United States
(12) Patent Application Publication
(10) Pub. No.: US 2025/0215148 A1
(43) Pub. Date: Jul. 3, 2025

(54) RESIN COMPOSITION FOR OPTICAL WAVEGUIDES, DRY FILM FOR OPTICAL WAVEGUIDES, AND OPTICAL WAVEGUIDE

(71) Applicant: Panasonic Intellectual Property Management Co., Ltd., Osaka (JP)

(72) Inventors: Toru NAKASHIBA, Osaka (JP); Toru ENDO, Osaka (JP); Eiichiro SAITO, Osaka (JP)

(73) Assignee: Panasonic Intellectual Property Management Co., Ltd., Osaka (JP)

(21) Appl. No.: 18/850,254

(22) PCT Filed: Mar. 29, 2023
(86) PCT No.: PCT/JP2023/012830

§ 371 Date: Sep. 24, 2024

(30) Foreign Application Priority Data
Mar. 31, 2022 (JP) 2022-061183

(51) Int. Cl. C08G 59/68; C08G 59/32; C08G 59/38; G02B 1/04

(52) U.S. Cl. CPC C08G 59/687; C08G 59/3218; C08G 59/38; G02B 1/045

(57) ABSTRACT

A resin composition according to the present disclosure is designed for use in optical waveguides. The resin composition contains an epoxy resin (A) and a photocuring agent (B). The photocuring agent (B) includes a borate (B-1) having a boron anion.

### TECHNICAL FIELD

The present disclosure relates to a resin composition for use in optical waveguides, a dry film for use in optical waveguides, and an optical waveguide.

### BACKGROUND ART

In the field of middle-range communications such as fiber to the home (FTTH) and onboard equipment, a fiber-optic cable is used as a transmission medium. In the field of short-range communications, however, there is a growing demand for high-density wiring that has a narrow pitch, branches, intersections, and multilayer structure, for example, which are difficult to realize by a fiber-optic cable. Thus, an optical wiring board including an optical waveguide that satisfies all of these requirements and a hybrid optical-electrical board including an electric circuit have been proposed to meet such a demand.

Examples of optical waveguides include a polymer optical waveguide which uses a resin material. The optical waveguide provided for a hybrid optical-electrical board is preferably the polymer optical waveguide, considering its compatibility with a wiring board including an electric circuit.

Examples of materials for such an optical waveguide include a composition for optical waveguides which uses an epoxy resin as disclosed in Patent Literature 1. Patent Literature 1 discloses a composition for optical waveguides which may be used to form a highly heat-resistant optical waveguide.

A process for forming an optical waveguide includes the process step of photocuring a resin composition for optical waveguides by irradiating the resin composition with a light ray. In this process step, the resin composition for optical waveguides needs to be sufficiently photocured to cut down the optical loss caused by the optical waveguide. Thus, a photocuring agent for accelerating the photocuring is generally contained in the resin composition for optical waveguides.

A method called “direct imaging (DI)” is one of the methods for irradiating a target with a light ray. The DI method has attracted a lot of attention from the art because the DI method allows an exposure pattern to be formed with high positioning accuracy even without using a photomask when irradiating the target with a light ray. A light source for use in the DI method has, in most cases, a wavelength of 365 nm or 407 nm, at which the resin composition for optical waveguides to be photocured needs to have a high degree of photosensitivity. The composition for optical waveguides as disclosed in Patent Literature 1 does not have so high a degree of photosensitivity as to be used effectively in the DI method, and therefore, still has room for improvement in this respect.

### CITATION LIST

### Patent Literature

Patent Literature 1: JP 2020-184091 A

### SUMMARY OF INVENTION

An object of the present disclosure is to provide a resin composition for use in optical waveguides which has an excellent degree of photocurability, a dry film for use in optical waveguides, and an optical waveguide containing a cured product thereof.

A resin composition according to an aspect of the present disclosure is designed for use in optical waveguides. The resin composition contains an epoxy resin (A) and a photocuring agent (B). The photocuring agent (B) includes a borate (B-1) having a boron anion.

A dry film according to another aspect of the present disclosure is designed for use in optical waveguides. The dry film includes a resin layer containing either the resin composition described above, or a semi-cured product of the resin composition described above.

An optical waveguide according to still another aspect of the present disclosure includes a core and a cladding layer that covers the core. At least one of the core or the cladding layer contains a cured product of the resin composition described above.

### BRIEF DESCRIPTION OF DRAWINGS

FIG. 1 is a cross-sectional view illustrating a configuration for a dry film for optical waveguides according to an exemplary embodiment:

FIGS. 2A-2D illustrate a method for manufacturing a hybrid optical-electrical board including an optical waveguide according to the exemplary embodiment; and

FIGS. 3A-3D illustrate the method for manufacturing the hybrid optical-electrical board including the optical waveguide according to the exemplary embodiment.

### DESCRIPTION OF EMBODIMENTS

### 1. Resin Composition for Optical Waveguides

A resin composition for use in optical waveguides (hereinafter simply referred to as a “resin composition for optical waveguides”) according to an exemplary embodiment contains an epoxy resin (A) and a photocuring agent (B). This resin composition for optical waveguides has a high degree of photosensitivity to a light ray falling within the i-line range.

### <Epoxy Resin (A)>

The epoxy resin (A) includes an epoxy compound with a high degree of photocurability and a high degree of light transmitting property. The epoxy resin (A) preferably includes at least one selected from the group consisting of a liquid aliphatic epoxy compound (A-1), a polyfunctional aromatic epoxy compound (A-2) having three or more epoxy groups in its molecule, and a solid bisphenol A epoxy compound (A-3). More preferably, the epoxy resin (A) includes all of the liquid aliphatic epoxy compound (A-1), the polyfunctional aromatic epoxy compound (A-2) having three or more epoxy groups in its molecule, and the solid bisphenol A epoxy compound (A-3).

The liquid aliphatic epoxy compound (A-1) is an aliphatic epoxy compound which is liquid and non-aromatic at 25° C. The viscosity of the liquid aliphatic epoxy compound (A-1) at 25° C. is preferably equal to or greater than 100 mPas. On the other hand, the viscosity of the liquid aliphatic epoxy compound (A-1) at 25° C. is preferably equal to or less than 1500 mPa·s. Specific examples of the liquid aliphatic epoxy compound (A-1) include 3,4-epoxycyclohexylmethyl (3,4-epoxy)cyclohexane carboxylate and trimethylolpropane polyglycidyl ether. Examples of the 3,4-epoxycyclohexylmethyl (3,4-epoxy)cyclohexane carboxylate include Celloxide 2021P manufactured by Daicel Corporation. Furthermore, examples of the trimethylolpropane polyglycidyl ether include YH-300 manufactured by Nippon Steel & Sumikin Chemical & Material Co., Ltd. and EX-321L manufactured by Nagase ChemteX Corporation. As the liquid aliphatic epoxy compound (A-1), any of the compounds exemplified above may be used by itself, or two or more compounds selected from those compounds may be used in combination, whichever is appropriate.

The content of the liquid aliphatic epoxy compound (A-1) is preferably equal to or greater than 10% by mass, and more preferably equal to or greater than 15% by mass, with respect to the entire mass of the epoxy resin (A). On the other hand, the content of the liquid aliphatic epoxy compound (A-1) is preferably equal to or less than 30% by mass, and more preferably equal to or less than 25% by mass, with respect to the entire mass of the epoxy resin (A). If the content of the liquid aliphatic epoxy compound (A-1) were too little or too much, it would be difficult to form the optical waveguide.

Specifically, if the content of the liquid aliphatic epoxy compound (A-1) were too little, a decline would be caused in the flexibility of a dry film made of the resin composition for optical waveguides.

On the other hand, if the content of the liquid aliphatic epoxy compound (A-1) were too much, a dry film made of the resin composition for optical waveguides would have an increased degree of tackiness and a decreased degree of handleability. In view of these considerations, if the content of the liquid aliphatic epoxy compound (A-1) falls within the above-defined range, then a dry film and an optical waveguide may be formed advantageously.

The polyfunctional aromatic epoxy compound (A-2) is not limited to any particular compound as long as the polyfunctional aromatic epoxy compound (A-2) includes three or more epoxy groups in its molecule and is an aromatic epoxy compound. Specifically, examples of the polyfunctional aromatic epoxy compound (A-2) include 2-[4-(2,3-epoxypropoxy)phenyl]-2-[4 [1,1-bis [4-([2,3-epoxypropoxy]phenyl)]ethyl]phenyl]propane. Furthermore, examples of the polyfunctional aromatic epoxy compound (A-2) include VG3101 manufactured by Printec Corporation.

The content of the polyfunctional aromatic epoxy compound (A-2) is preferably equal to or greater than 10% by mass, more preferably equal to or greater than 20% by mass, and even more preferably equal to or greater than 25% by mass, with respect to the entire mass of the epoxy resin (A). On the other hand, the content of the polyfunctional aromatic epoxy compound (A-2) is preferably equal to or less than 60% by mass, more preferably equal to or less than 50% by mass, and even more preferably equal to or less than 40% by mass, with respect to the entire mass of the epoxy resin (A). If the content of the polyfunctional aromatic epoxy compound (A-2) were too little or too much, then a decline would be caused in the heat resistance and mechanical strength of the optical waveguide.

Specifically, if the content of the polyfunctional aromatic epoxy compound (A-2) were too little, then a cured product thereof would have a decreased degree of heat resistance. On the other hand, if the content of the polyfunctional aromatic epoxy compound (A-2) were too much, then the cured product thereof would become too brittle. In view of these considerations, an advantageous optical waveguide may be formed as long as the content of the polyfunctional aromatic epoxy compound (A-2) falls within the above-defined range.

The solid bisphenol A epoxy compound (A-3) is a bisphenol A epoxy compound which is in solid form at 25° C., and which includes an epoxy group or two in its molecule. The epoxy equivalent of the solid bisphenol A epoxy compound (A-3) is preferably equal to or greater than 400 g/eq, more preferably equal to or greater than 670 g/eq, and even more preferably equal to or greater than 900 g/eq. On the other hand, the epoxy equivalent of the solid bisphenol A epoxy compound (A-3) is preferably equal to or less than 1500 g/eq and more preferably equal to or less than 1100 g/eq. If the epoxy equivalent were too small or too large, it would be difficult to form the optical waveguide. Specifically, if the epoxy equivalent were too small, it would be difficult to form the dry film. On the other hand, if the epoxy equivalent were too large, then the developability would decline too much to have development done smoothly when either the core or cladding layer of the optical waveguide is formed. In view of these considerations, the optical waveguide may be formed advantageously as long as the epoxy equivalent of the solid bisphenol A epoxy compound (A-3) falls within the above-defined range.

Examples of the solid bisphenol A epoxy compound (A-3) include 1001, 1002, 1003, 1055, 1004, 1004AF, 1003F, 1004F, 1005F, 1004FS, 1006FS, and 1007FS, all of which are manufactured by Mitsubishi Chemical Corporation. Also, as the solid bisphenol A epoxy compound (A-3), any of the compounds exemplified above may be used by itself, or two or more compounds selected from those compounds may be used in combination, whichever is appropriate.

The content of the solid bisphenol A epoxy compound (A-3) is preferably equal to or greater than 10% by mass, more preferably equal to or greater than 20% by mass, and even more preferably equal to or greater than 25% by mass, with respect to the entire mass of the epoxy resin (A). On the other hand, the content of the solid bisphenol A epoxy compound (A-3) is preferably equal to or less than 70% by mass, more preferably equal to or less than 65% by mass, and even more preferably equal to or less than 60% by mass, with respect to the entire mass of the epoxy resin (A). If the content of the solid bisphenol A epoxy compound (A-3) were too little or too much, then it would be difficult to form the optical waveguide. Specifically, if the content of the solid bisphenol A epoxy compound (A-3) were too little, then a decline would be caused in the flexibility of a dry film made of the resin composition for optical waveguides when the optical waveguide is formed. On the other hand, if the content of the solid bisphenol A epoxy compound (A-3) were too much, then the cured product thereof would have too low a degree of heat resistance to avoid becoming brittle. In view of these considerations, an advantageous optical waveguide may be formed as long as the content of the solid bisphenol A epoxy compound (A-3) falls within the above-defined range.

The epoxy resin (A) preferably further includes a solid chain aliphatic epoxy compound which is in solid form at 25° C. and which has two or more epoxy groups in its molecule. This configuration provides a resin composition for optical waveguides which may be used to form the cladding of a highly heat-resistant optical waveguide advantageously among other optical waveguides.

The solid chain aliphatic epoxy compound is preferably a solid hydrogenated bisphenol A epoxy compound. This configuration provides a resin composition for optical waveguides which may be used to form the cladding of a highly heat-resistant optical waveguide more advantageously.

The content of the solid chain aliphatic epoxy compound is preferably equal to or less than 70% by mass to the entire mass of the epoxy resin (A). This configuration provides a resin composition for optical waveguides which may be used to form the cladding of a highly heat-resistant optical waveguide advantageously among other optical waveguides.

Note that in the epoxy resin (A), the respective contents of a bisphenol A epoxy compound which is in liquid form at 25° C., a phenol-novolac epoxy compound, a cresol-novolac epoxy compound, and an alicyclic epoxy compound which is in solid form at 25° C. and which includes three or more epoxy groups in its molecule are preferably as little as possible. Specifically, the contents of these epoxy compounds are preferably equal to or less than 5% by mass, more preferably equal to or less than 3% by mass, and even more preferably 0% by mass, with respect to the entire mass of the epoxy resin (A). If the contents of these epoxy compounds were too much, then it would be impossible to increase the heat resistance of the resultant cured product sufficiently.

<Photocuring agent (B)>

The The photocuring agent (B) includes a borate (B-1) having a boron anion. photocuring agent (B) is not limited to any particular compound as long as the photocuring agent (B) may accelerate photocuring of the epoxy resin (A), i.e., the resin composition for optical waveguides, when irradiated with a light ray falling within the i-line range.

The borate (B-1) is a photocuring agent having a boron anion. The borate (B-1) may be used to form an advantageous optical waveguide by irradiating the borate (B-1) with a light ray falling within the i-line range. Also, the borate (B-1) has a high degree of photosensitivity to a light ray falling within the i-line range. Note that the borate (B-1) also has photosensitivity to a light ray having a wavelength falling outside of the i-line range.

The borate (B-1) is not limited to any particular compound as long as the borate (B-1) has a boron anion. The borate (B-1) preferably has a monovalent boron anion and preferably has a boron anion expressed by RₐBF₄₋ₐ⁻, where R is a fluorinated hydrocarbon group and a is an integer equal to or greater than 0 and equal to or less than 4. If a is an integer equal to or greater than 2 and equal to or less than 4, R's are independent of each other.

Specific examples of the fluorinated hydrocarbon group include a fluoromethyl group, a trifluoromethyl group, and a fluorophenyl group. Among other things, a fluorophenyl group is preferred. A fluorophenyl group herein refers to a phenyl group in which at least one hydrogen atom is replaced with either fluorine or a substituent including fluorine. Specific examples of the fluorophenyl group include C₆F₅, C₆H₃F₂, CF₃C₆H₄, and (CF₃)₂C₆H₃. Such a boron anion has a high degree of photosensitivity to a light ray falling within the i-line range and may be used to form the optical waveguide advantageously.

Specific examples of the boron anion included in the borate (B-1) include BF₄⁻, (C₆F₅)₄B⁻, (CF₃C₆H₄)₄B⁻, ((CF₃)₂C₆H₃)₄B⁻, (C₆F₅)₂BF₂, C₆F₅BF₃, (C₆H₃F₂)₄B⁻, (C₆H₅)₄B⁻, and CH₃CH₂CH₂CH₂B (C₆H₅)₃. Such a boron anion has a higher degree of photosensitivity to a light ray falling within the i-line range and may be used to form the optical waveguide advantageously.

Specific examples of the boron anion expressed by RₐBF₄₋ₐ ⁻include BF₄, (C₆F₅)₄B⁻, (CF₃C₆H₄)₄B⁻, ((CF₃)₂C₆H₃)₄B⁻, (C₆F₅)₂BF₂, C₆F₅BF₃⁻, and (C₆H₃F₂)₄B⁻. Among other things, BF₄⁻, (C₆F₅)₄B⁻, and ((CF₃)₂C₆H₃)₄B⁻ are preferred. More preferably, the boron anion expressed by RₐBF₄₋ₐ ⁻ is (C₆F₅)₄B⁻. Such a boron anion has an even higher degree of photosensitivity to a light ray falling within the i-line range and may be used to form the optical waveguide advantageously.

Also, the cation included in the borate (B-1) is not limited to any particular cation as long as the cation is a sulfonium cation. Specifically, the cation expressed by the following formula (1) is preferably included in the borate (B-1):

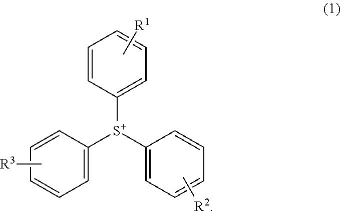

In the formula (1), R¹ is selected from the group consisting of a phenylthio group, a 4-biphenylylthio group, a 4-biphenoxy group, a 2-naphthylthio group, a 2-naphthoxy group, a 4-(4-acetyl)phenylthio group, and a 4-(4-benzoyl)phenylthio group; R² is selected from the group consisting of a 4-biphenylylthio group, a 4-biphenoxy group, a 2-naphthylthio group, a 2-naphthoxy group, and a hydrogen atom; and R³ is selected from the group consisting of a 4-biphenylylthio group, a 2-naphthylthio group, a methoxy group, a methyl group, a bromo group, a chloro group, and a hydrogen atom. A borate (B-1) including a sulfonium cation with such a substituent has a high degree of photosensitivity to a light ray falling within the i-line range and may be used to form the optical waveguide advantageously.

If R¹ and R² are the same substituent, then R¹ and R² are preferably selected from the group consisting of the 4-biphenylylthio group and the 2-naphthylthio group. On the other hand, if R¹ and R² are different substituents, then R¹ is preferably selected from the group consisting of the 4-(4-acetyl)phenylthio group and the 4-(4-benzoyl)phenylthio group and R² and R³ are preferably a hydrogen atom. A borate (B-1) including a sulfonium cation with such a substituent has a high degree of photosensitivity to a light ray falling within the i-line range and may be used to form the optical waveguide advantageously.

The content of the photocuring agent (B) is preferably equal to or greater than 0.05 parts by mass with respect to 100 parts by mass of the epoxy resin (A). On the other hand, the content of the photocuring agent (B) is preferably equal to or less than 5 parts by mass with respect to 100 parts by mass of the epoxy resin (A). If the content of the photocuring agent (B) falls within this range, then appropriate amounts of cations and anions are produced. This enables using the resin composition for optical waveguides to form an advantageous optical waveguide without causing any decline in storage stability or handleability.

The borate (B-1) may be used by itself. Alternatively, two or more borates (B-1) may be used in combination. The content of the borate (B-1) is preferably equal to or greater than 0.05 parts by mass, more preferably equal to or greater than 0.07 parts by mass, and even more preferably equal to or greater than 0.1 parts by mass, with respect to 100 parts by mass of the epoxy resin (A). On the other hand, the content of the borate (B-1) is preferably equal to or less than 0.8 parts by mass, more preferably equal to or less than 0.7 parts by mass, and even more preferably equal to or less than 0.6 parts by mass, with respect to 100 parts by mass of the epoxy resin (A). If the content of the borate (B-1) falls within this range, then appropriate amounts of cations and anions are produced. This enables using the resin composition for optical waveguides to form an advantageous optical waveguide without causing any decline in storage stability or handleability.

### <Additives>

The resin composition for optical waveguides may contain additives as long as the advantages of this embodiment are not impaired. Examples of the additives include, without limitation, antioxidants, leveling agents, and solvents.

Examples of the antioxidants include, without limitation, phenolic antioxidants, phosphite antioxidants, and sulfur-based antioxidants. Among other things, phenolic antioxidants are particularly preferred.

Examples of the phenolic antioxidants include AO-20, AO-30, AO-40, AO-50, AO-60, and AO-80 manufactured by ADEKA Corporation and SUMILIZER GA-80 manufactured by Sumitomo Chemical Co., Ltd.

Examples of the phosphite antioxidants include PEP-8, PEP-36, HP-10, 2112, 1178, and 1500 manufactured by ADEKA Corporation, and JP-360 and JP-3CP manufactured by Johoku Chemical Co., Ltd.

Examples of the sulfur-based antioxidants include AO-412S and AO-503 manufactured by ADEKA Corporation, and SUMILIZER TP-D manufactured by Sumitomo Chemical Co., Ltd.

As the antioxidant, any of the compounds described above may be used by itself, or two or more compounds selected from those compounds may be used in combination, whichever is appropriate. Nevertheless, it is preferable that a phenolic antioxidant be used by itself. A highly heat-resistant optical waveguide may be formed advantageously by adding the antioxidant to the resin composition for optical waveguides.

The content of the antioxidant is preferably equal to or greater than 0 parts by mass, more preferably equal to or greater than 0.2 parts by mass, and even more preferably equal to or greater than 0.3 parts by mass, with respect to 100 parts by mass of the epoxy resin (A). On the other hand, the content of the antioxidant is preferably equal to or less than 5 parts by mass, more preferably equal to or less than 2 parts by mass, and even more preferably equal to or less than 1 part by mass, with respect to 100 parts by mass of the epoxy resin (A). In a situation where any antioxidant is added, the heat resistance of the cured product could not be increased sufficiently if the antioxidant were too little or too much. Specifically, if the antioxidant were too little, then it would be difficult to achieve the expected effect even by adding the antioxidant and the heat resistance of the cured product could not be increased sufficiently. Meanwhile, if the antioxidant were too much, then the antioxidant would serve as a plasticizer, thus possibly causing a decline in the heat resistance of the cured product. In view of these considerations, a highly heat-resistant optical waveguide may be formed advantageously as long as the content of the antioxidant falls within the above-described range.

As the leveling agent, any of various dispersants which are generally used as dispersants may be used. For example, PF-636 manufactured by OMNOVA Solutions may be used.

As can be seen from the foregoing description, the resin composition for optical waveguides according to this embodiment may be used to form a highly heat-resistant optical waveguide.

### <Curing Method>

Any method may be used without limitation to cure the resin composition for optical waveguides as long as the method allows photocuring to advance. Specifically, a method in which the resin composition for optical waveguides is irradiated with a light ray having a wavelength of 365 nm at a dose of 1000 mJ/cm² and subjected to a heat treatment at 140° C. for 10 minutes may be used, for example. Note that the absorption wavelength and the heat treatment condition are not limited to any particular ones as long as the photocuring is allowed to advance.

According to this method, the proportion of the epoxy groups included in the resin composition for optical waveguides which has been cured is preferably equal to or less than 30%, more preferably equal to or less than 21%, and even more preferably equal to or less than 16%, with respect to 100% of epoxy groups included in the resin composition for optical waveguides which has not been cured yet. It can be said that the smaller the proportion of the epoxy groups included in the cured product of the resin composition for optical waveguides is, the more significantly the photocuring has advanced.

Note that the “proportion of the epoxy groups” as used herein is calculated based on peaks of the epoxy groups in an IR spectrum obtained by measurement using a Fourier transform infrared spectrophotometer (FT-IR). More specifically, the proportion of the epoxy groups is calculated by comparing the peak (912 cm-1) areas of the quantified epoxy groups in FT-IR data (IR spectrum, of which the abscissa indicates the wavelength, and the ordinate indicates absorbance (Abs)). A peak of a benzene ring (830 cm-1), which has a stabilized composition, is used as a reference for quantification.

That is to say, the “proportion of the epoxy groups” as used herein is “proportion of epoxy groups=peak areas of epoxy groups/peak area of benzene ring.” Note that a baseline for determining the area is defined by drawing a tangential line that passes through two points representing the local minimum values of right and left peaks in the graph representing the IR spectrum.

As can be seen from the foregoing description, the photocuring is allowed to advance sufficiently by irradiating the resin composition with a light ray having a wavelength of 365 nm and by subjecting the resin composition to a heat treatment at 140° C. for 10 minutes. Thus, the resin composition for optical waveguides according to this embodiment may be used to mass produce advantageous optical waveguides by the DI method using a light ray having a wavelength of 365 nm.

Note that photocuring of the resin composition for optical waveguides according to this embodiment is also allowed to advance in the same manner, and an advantageous optical waveguide may also be formed, even by projection exposure using a photomask. Alternatively, the photocuring may also be advanced by using a light ray falling outside of the i-line range.

### 2. Dry Film for Optical Waveguides and Optical Waveguide

The resin composition for optical waveguides according to this embodiment may also be used as a material for a dry film which is used when an optical waveguide is formed.

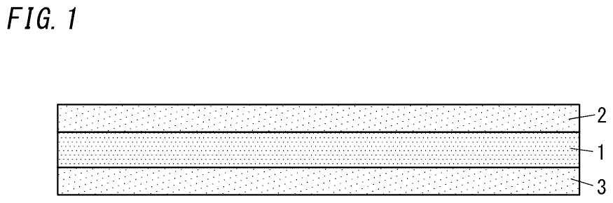

The dry film for use in optical waveguides (hereinafter simply referred to as a “dry film for optical waveguides”) according to this embodiment is not limited to any particular one as long as the dry film includes a resin layer including either the resin composition for optical waveguides or a semi-cured product of the resin composition for optical waveguides (hereinafter simply referred to as an “optical waveguide resin composition layer 1”). Specifically, the dry film for optical waveguides may include a film base member 2 on one surface of the optical waveguide resin composition layer 1 and a protective film 3 on the other surface of the optical waveguide resin composition layer 1 as shown in FIG. 1. This makes the dry film for optical waveguides more easily handleable. Note that the dry film for optical waveguides only needs to include the optical waveguide resin composition layer 1 and may include not only the film base member 2 and the protective film 3 but also other layers as well. Note that the film base member 2 and the protective film 3 are not essential constituent elements. FIG. 1 is a cross-sectional view illustrating a configuration for a dry film for optical waveguides according to this embodiment.

Examples of the film base member 2 include, without limitation, a polyethylene terephthalate (PET) film, a biaxially oriented polypropylene film, a polyethylene naphthalate film, and a polyimide film. Among other things, a PET film is preferably used.

The protective film 3 may be, without limitation, a polypropylene film, for example.

A method for forming the dry film for optical waveguides may be, without limitation, the following method, for example. First, a solvent, for example, is added to the resin composition for optical waveguides to turn the resin composition and the solvent into varnish. The varnish is then applied onto the film base member 2. The varnish may be applied, for example, using a comma coater. The varnish is dried, thereby forming an optical waveguide resin composition layer 1 on the film base member 2. Then, a protective film 3 is further stacked on the optical waveguide resin composition layer 1. A thermal laminating method, for example, may be used as a method for stacking the protective film 3. The optical waveguide resin composition layer 1 included in the dry film for optical waveguides is used as a material for the optical waveguide. The dry film for optical waveguides may be used to form the core of the optical waveguide or the cladding thereof, whichever is appropriate. The resin composition for optical waveguides according to this embodiment does not have to be used in the form of the dry film but may also be used in the form of varnish, for example. This resin composition for optical waveguides, as well as the dry film for optical waveguides, may be used to form the core of the optical waveguide or the cladding thereof, whichever is appropriate. An optical waveguide formed by using the resin composition for optical waveguides and the dry film for optical waveguides as described above will have a high degree of heat resistance.

The optical waveguide resin composition layer 1 in the dry film for optical waveguides preferably has a thickness equal to or greater than 10 μm and more preferably has a thickness equal to or greater than 25 μm. Meanwhile, the optical waveguide resin composition layer 1 in the dry film for optical waveguides preferably has a thickness equal to or less than 100 μm and more preferably has a thickness equal to or less than 90 μm. Setting the thickness of the optical waveguide resin composition layer 1 at a value equal to or greater than 10 μm and equal to or less than 100 μm allows a good dry film to be obtained and also allows a good optical waveguide to be obtained after development.

An optical waveguide according to this embodiment includes a core and cladding layer that covers the core. At least one of the core or the cladding layer includes a cured product of the resin composition for optical waveguides. To increase the heat resistance, it is preferable that both the core and the cladding layer contain the cured product of the resin composition for optical waveguides.

An optical waveguide that has gone through the process step of irradiating the resin composition with a light ray having a wavelength of 365 nm at a dose of 1000 mJ/cm² and subjecting the resin composition to a heat treatment at 140° C. for 10 minutes preferably causes an initial optical loss equal to or less than 0.10 dB/cm, and more preferably causes an initial optical loss equal to or less than 0.09 dB/cm, at 850 nm.

Meanwhile, an optical waveguide that has gone through the process step of irradiating the resin composition with a light ray having a wavelength of 365 nm at a dose of 300 mJ/cm² and subjecting the resin composition to a heat treatment at 140° C. for 10 minutes preferably causes an initial optical loss equal to or less than 0.13 dB/cm, and more preferably causes an initial optical loss equal to or less than 0.12 dB/cm, at 850 nm.

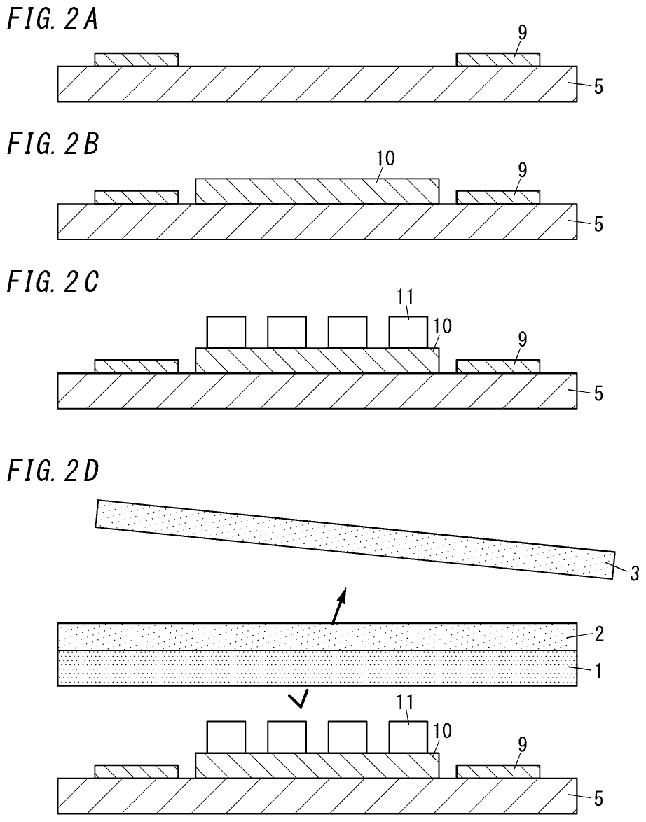

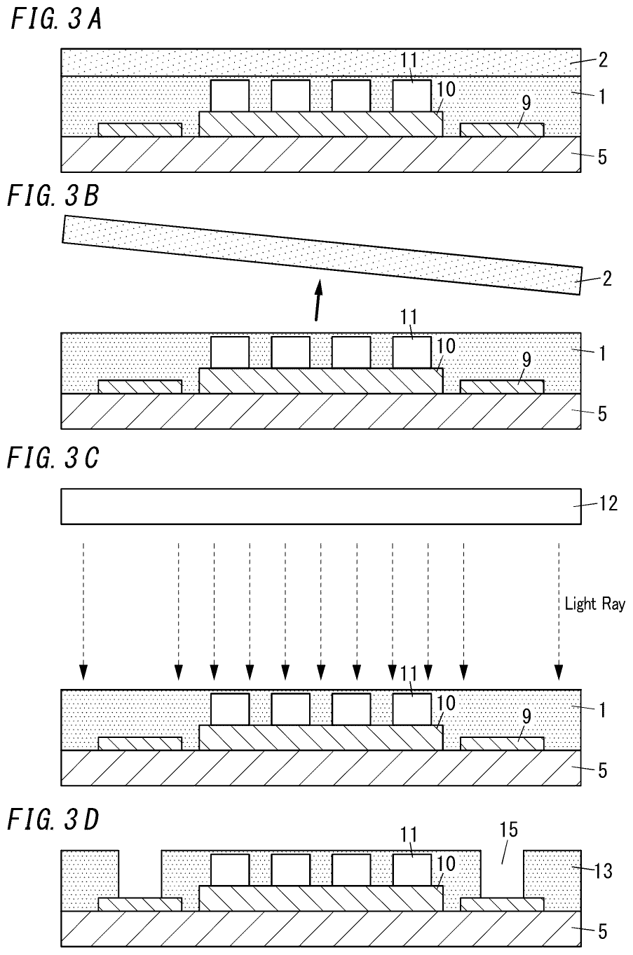

A method for forming an optical waveguide according to this embodiment will now be described with reference to FIGS. 2A-2D and FIGS. 3A-3D. In the following description, a method for manufacturing a hybrid optical-electrical board including the optical waveguide will be described. Note that FIGS. 2A-2D and FIGS. 3A-3D illustrate a method for manufacturing a hybrid optical-electrical board including the optical waveguide according to this embodiment.

First, as shown in FIG. 2A, a board 5 including an electric circuit 9 is provided. Next, as shown in FIG. 2B, a lower cladding layer 10 is formed on the surface of the board 5 on which the electric circuit 9 is provided. Next, as shown in FIG. 2C, a core 11 is formed on the lower cladding layer 10.

Next, an upper cladding layer 13 is formed out of the dry film for optical waveguides. Specifically, as shown in FIG. 2D, the protective film 3 is peeled off the dry film for optical waveguides. Thereafter, as shown in FIG. 3A, the dry film for optical waveguides, from which the protective film 3 has been peeled off, is stacked on the assembly such that the optical waveguide resin composition layer 1 covers the lower cladding layer 10 and the core 11. Subsequently, as shown in FIG. 3B, the film base member 2 is peeled off the dry film for optical waveguides. Next, as shown in FIG. 3C, the optical waveguide resin composition layer 1 is irradiated with, and thereby photocured by, a light ray emitted from a light source 12 at a wavelength of 365 nm. This turns the optical waveguide resin composition layer 1 into an upper cladding layer 13.

Note that via holes 15 may be formed as shown in FIG. 3D by irradiating the entire optical waveguide resin composition layer 1 but its parts to be via holes 15 with the light ray having the wavelength of 365 nm as shown in FIG. 3C and then developing the optical waveguide resin composition layer 1.

An optical waveguide may be formed in this manner by using the dry film for optical waveguides according to this embodiment. That is to say, the optical waveguide shown in FIG. 3D includes the core 11, the lower cladding layer 10, and the upper cladding layer 13. The upper cladding layer 13 covers the core 11. The upper cladding layer 13 is a cured product of the resin composition for optical waveguides. Although the dry film for optical waveguides is used in this embodiment to form the upper cladding layer 13, the dry film for optical waveguides may also be used to form the lower cladding layer 10 or the core 11.

As can be seen from the foregoing description, the dry film for optical waveguides according to this embodiment includes the optical waveguide resin composition layer 1.

Also, the optical waveguide according to this embodiment includes a core and a cladding layer that covers the core. At least one of the core or the cladding layer includes a cured product of the resin composition for optical waveguides.

### 3. Aspects

As can be seen from the foregoing description of exemplary embodiments, the present disclosure has the following aspects. In the following description, reference signs are added in parentheses to the respective constituent elements solely for the purpose of clarifying the correspondence between the following aspects of the present disclosure and the exemplary embodiments described above.

A first aspect is a resin composition designed for use in optical waveguides. The resin composition contains an epoxy resin (A) and a photocuring agent (B). The photocuring agent (B) includes a borate (B-1) having a boron anion.

According to this aspect, photocuring of the resin composition for optical waveguides is allowed to advance by irradiating the resin composition with a light ray falling within an i-line range (from 355 nm through 390 nm), thus enabling forming an optical waveguide efficiently by the DI method.

A second aspect is a resin composition for optical waveguides which may be implemented in conjunction with the first aspect. In the second aspect, the borate (B-1) has a boron anion expressed by RₐBF₄-a, where R is each independently a fluorinated hydrocarbon group and a is an integer equal to or greater than 0 and equal to or less than 4.

This aspect enables forming a more advantageous optical waveguide by irradiating the resin composition with a light ray falling within the i-line range.

A third aspect is a resin composition for optical waveguides which may be implemented in conjunction with the first or second aspect. In the third aspect, the borate (B-1) has a boron anion expressed by (C₆F₅)₄B.

This aspect enables forming an advantageous optical waveguide having an even higher degree of photosensitivity to a light ray falling within the i-line range.

A fourth aspect is a resin composition for optical waveguides which may be implemented in conjunction with any one of the first to third aspects. In the fourth aspect, the borate (B-1) has a cation expressed by the following formula (1):

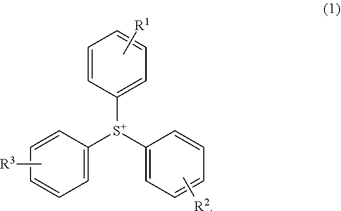

In the formula (1), R¹ is selected from the group consisting of a phenylthio group, a 4-biphenylylthio group, a 4-biphenoxy group, a 2-naphthylthio group, a 2-naphthoxy group, a 4-(4-acetyl)phenylthio group, and a 4-(4-benzoyl)phenylthio group; R² is selected from the group consisting of a 4-biphenylylthio group, a 4-biphenoxy group, a 2-naphthylthio group, a 2-naphthoxy group, and a hydrogen atom; and R³ is selected from the group consisting of a 4-biphenylylthio group, a 2-naphthylthio group, a methoxy group, a methyl group, a bromo group, a chloro group, and a hydrogen atom.

This aspect enables forming an advantageous optical waveguide having a high degree of photosensitivity to a light ray falling within the i-line range.

A fifth aspect is a resin composition for optical waveguides which may be implemented in conjunction with any one of the first to fourth aspects. In the fifth aspect, the content of the borate (B-1) is equal to or greater than 0.05 parts by mass and equal to or less than 0.8 parts by mass with respect to 100 parts by mass of the epoxy resin (A).

This aspect causes appropriate amounts of cations and anions to be produced. This enables using the resin composition for optical waveguides to form an advantageous optical waveguide without causing any decline in storage stability or handleability.

A sixth aspect is a resin composition for optical waveguides which may be implemented in conjunction with any one of the first to fifth aspects. In the sixth aspect, the epoxy resin (A) includes at least one selected from the group consisting of a liquid aliphatic epoxy compound (A-1), a polyfunctional aromatic epoxy compound (A-2) having three or more epoxy groups in its molecule, and a solid bisphenol A epoxy compound (A-3).

This aspect allows an optical waveguide to be formed even more advantageously.

A seventh aspect is a resin composition for optical waveguides which may be implemented in conjunction with the sixth aspect. In the seventh aspect, the content of the liquid aliphatic epoxy compound (A-1) is equal to or greater than 10% by mass and equal to or less than 30% by mass with respect to the entire mass of the epoxy resin (A).

This aspect makes it easier to form the optical waveguide.

An eighth aspect is a resin composition for optical waveguides which may be implemented in conjunction with the sixth aspect. In the eighth aspect, the content of the polyfunctional aromatic epoxy compound (A-2) is equal to or greater than 10% by mass and equal to or less than 60% by mass with respect to the entire mass of the epoxy resin (A).

This aspect may reduce the chances of causing a decline in the heat resistance and mechanical strength of the optical waveguide.

A ninth aspect is a resin composition for optical waveguides which may be implemented in conjunction with the sixth aspect. In the ninth aspect, the content of the solid bisphenol A epoxy compound (A-3) is equal to or greater than 10% by mass and equal to or less than 70% by mass with respect to the entire mass of the epoxy resin (A).

This aspect allows an optical waveguide to be formed advantageously.

A tenth aspect is a resin composition for optical waveguides which may be implemented in conjunction with any one of the first to ninth aspects. In the tenth aspect, the resin composition further contains an antioxidant.

This aspect allows a highly heat-resistant optical waveguide to be formed advantageously.

An eleventh aspect is a resin composition for optical waveguides which may be implemented in conjunction with any one of the first to tenth aspects. In the eleventh aspect, the proportion of epoxy groups included in the resin composition for optical waveguides which has been cured by irradiating the resin composition with a light ray having a wavelength of 365 nm at a dose of 1000 mJ/cm² and subjecting the resin composition to a heat treatment at 140° C. for 10 minutes to 100% of epoxy groups included in the resin composition for optical waveguides which has not been cured yet is equal to or less than 30%.

This aspect allows photocuring to advance.

A twelfth aspect is a resin composition for optical waveguides which may be implemented in conjunction with the eleventh aspect. In the twelfth aspect, an optical loss caused when light having a wavelength of 850 nm is allowed to pass through an optical waveguide along a longitudinal axis of the optical waveguide is equal to or less than 0.10 dB/cm. The optical waveguide is made of a cured product of the resin composition for optical waveguides and has a length of 50 mm, a thickness of 35 μm, and a width of 35 μm.

This aspect enables cutting down the optical loss caused by the optical waveguide.

A thirteenth aspect is a dry film designed for use in optical waveguides. The dry film includes a resin layer (1) containing either the resin composition according to any one of the first to twelfth aspects or a semi-cured product of the resin composition.

This aspect allows the dry film to be used to form either the core (11) or cladding layer (10, 13) of the optical waveguide.

A fourteenth aspect is a dry film for optical waveguides which may be implemented in conjunction with the thirteenth aspect. In the fourteenth aspect, the dry film further includes at least one film selected from the group consisting of a film base member (2) and a protective film (3).

This aspect increases the handleability of the dry film for optical waveguides.

A fifteenth aspect is an optical waveguide which includes a core (11) and a cladding layer (10, 13) that covers the core (11). At least one of the core (11) or the cladding layer (10, 13) contains a cured product of the resin composition according to any one of the first to twelfth aspects.

This aspect enables cutting down the optical loss.

### EXAMPLES

Next, specific examples of the present disclosure will be described. Note that the examples to be described below are only examples of the present disclosure and should not be construed as limiting.

### [Epoxy Resin (A)]

Liquid aliphatic epoxy compound (A-1): product name: Celloxide 2021P, manufactured by Daicel Corporation, having an epoxy equivalent of 128-133 g/eq;
Polyfunctional aromatic epoxy compound (A-2): product name: VG3101, manufactured by Printec Corporation; and
Solid bisphenol A epoxy compound (A-3): product name: 1006FS, manufactured by Mitsubishi Chemical Corporation, having an epoxy equivalent of 900-1100 g/eq.

### [Photocuring Agent (B)]

Borate (B-1): product name: CPI-310B, manufactured by San-Apro Ltd.; and
Antimonate, product name: SP-170, manufactured by ADEKA Corporation.

### [Additives]

Antioxidant: product name: AO-60 manufactured by ADEKA Corporation; and
Leveling agent: product name: PF-636, manufactured by OMNOVA Solutions.

[Resin Composition for Optical Waveguides]

Resin compositions for optical waveguides according to Examples 1˜4 and Comparative Example 1 were prepared in the following manner. First, respective materials were weighed in a glass container to have any of the chemical makeups (parts by mass) shown in the following Table 1 and 2-butanone, toluene, and propylene glycol monomethyl ether acetate were added thereto as solvents at a ratio of 7:2: 1. Thereafter, the compound thus prepared was stirred up under a reflux at 80° C., thereby obtaining a composition in the form of uniform varnish in which all dissolvable solid content was dissolved. The composition thus obtained in the form of varnish was filtered through a membrane filter made of polytetrafluoroethylene (PTFE) and having a pore diameter of 1 μm. This allowed solid foreign matter contained to be removed. After that, the resin composition for optical waveguides which had been filtered in the form of varnish was used.

### [Dry Film for Optical Waveguides]

Next, a dry film was formed out of each of the resin compositions for optical waveguides according to Examples 1˜4 and Comparative Example 1. Specifically, the resin composition for optical waveguides which had been obtained in the form of varnish was applied onto a PET film as a film base member (such as A4100 manufactured by Toyobo Co., Ltd.) using a multi-coater with a comma coater head manufactured by Hirano Tecseed Co., Ltd. such that a layer of the resin composition for optical waveguides had a thickness of 35 μm and then the assembly was dried at 130° C. for 10 minutes. In this manner, a layer of the resin composition for optical waveguides was formed to a thickness of 35 μm on the PET film. Next, an oriented polypropylene film was thermally laminated as a protective film on the layer of the resin composition for optical waveguides. In this manner, a dry film was obtained. The dry film thus obtained was irradiated with a light ray having a wavelength of 365 nm at a dose of 1000 mJ/cm² and subjected to a heat treatment at 140° C. for 10 minutes, thereby obtaining a cured film. The cured film thus obtained was evaluated in the following manner.

### [Ft-Ir Measurement]

The IR spectra of Examples 1˜4 and Comparative Example 1 were measured using model number Varian 610-IR manufactured by VARIAN, thereby calculating the proportion of epoxy groups included in the cured product. The results are shown, along with the chemical makeup of the composition, in the following Table 1:

TABLE 1

| | | | Ex. 1 | Ex. 2 | Ex. 3 | Ex. 4 | Cmp. Ex. 1 |
|---|---|---|---|---|---|---|---|
| Chemical | Epoxy Resin | Liquid aliphatic epoxy | 23 | 23 | 23 | 23 | 23 |
| Makeup | (A) | compound(A-1) | | | | | |
| (Parts by | | Polyfunctional aromatic | 21 | 21 | 21 | 21 | 21 |
| mass) | | epoxy compound (A-2) | | | | | |
| | | Solid bisphenol A epoxy | 56 | 56 | 56 | 56 | 56 |
| | | compound (A-3) | | | | | |
| | Photocuring | Borate (B-1) | 0.1 | 0.3 | 0.6 | 0.3 | — |
| | Agent (B) | Antimonate | — | — | — | — | 0.6 |
| | Additives | Antioxidant | 0.3 | 0.3 | 0.3 | 0.3 | 0.3 |
| | | Leveling agent | 0.1 | 0.1 | 0.1 | 0.1 | 0.1 |
| Irradiation | Dose (mJ/cm²) | | 1000 | 1000 | 1000 | 300 | 1000 |
| Condition | | | | | | | |

| | | | | | | |
|---|---|---|---|---|---|---|
| Evaluation | Proportion (%) of epoxy groups | 21 | 16 | 16 | 34 | 48 |
| | included in cured product | | | | | |

### [Optical Waveguide]

Next, samples (representing Examples 5 and 6) in which an optical waveguide for evaluation had been formed were formed in the following manner.

First, a cladding dry film with a thickness of 50 μm was laminated, using a vacuum laminator, on a board (such as 1515W manufactured by Panasonic Corporation), from which copper had been etched off from both sides. The assembly was irradiated with an ultraviolet ray, the PET film was peeled off the cladding dry film, and then the assembly was subjected to a heating treatment at 140° C., thereby forming under cladding (i.e., lower cladding).

Thereafter, a core dry film with a thickness of 35 μm was laminated, using a vacuum laminator, on the surface of the under cladding. Next, the part to be photocured (i.e., a linear pattern portion with a width of 35 μm and a length of 50 mm) was irradiated with a light ray having a wavelength of 365 nm at a dose of 1000 mJ/cm² by the DI method and subjected to a heat treatment at 140° C. for 10 minutes, thereby photocuring an exposed portion of the core dry film.

Next, the assembly was subjected to a development treatment using an aqueous flux cleaning agent (Pine Alpha ST-100SX manufactured by Arakawa Chemical Industries, Ltd.), thereby removing an uncured part of the core dry film and forming a core by air blowing and drying.

Subsequently, a cladding dry film with a thickness of 50 μm was laminated using a vacuum laminator onto the core. The assembly was irradiated with an ultraviolet ray and then heated at 140° C., thereby photocuring the cladding dry film.

A piece was cut out of the board such that the waveguide pattern had a length of 50 mm and had its end faces polished, thereby obtaining a sample on which an optical waveguide for evaluation had been formed.

Note that in Examples 5 and 6, dry films with the chemical makeups of Examples 2 and 4 were used as the core dry films (refer to the following Table 2). In Examples 5 and 6, the same dry film was used as the cladding dry films. Specifically, a dry film made of a resin composition for optical waveguides, including 14 parts by mass of liquid aliphatic epoxy compound (A-1), 23 parts by mass of polyfunctional aromatic epoxy compound (A-2), 25 parts by mass of solid bisphenol A epoxy compound (A-3), 38 parts by mass of hydrogenated bisphenol A epoxy compound (product name YX8040 manufactured by Mitsubishi Chemical Corporation), 1.0 part by mass of antimonate, 1.4 parts by mass of antioxidant, and 0.1 parts by mass of leveling agent with respect to 100 parts by mass of the epoxy resin (A) was used as the cladding dry film. The antimonate, the antioxidant, and the leveling agent are as described above. The optical waveguide thus obtained was evaluated in the following manner:

[Initial waveguide loss]

Light emitted from a VCSEL light source having a wavelength of 850 nm was allowed to be incident onto one end face of the optical waveguide from an optical fiber with a core diameter of 10 μm and an NA of 0.21 and then was allowed to emerge from the other end face of the optical waveguide through an optical fiber with a core diameter of 200 μm and an NA of 0.4. The power (P1) of the light thus allowed to emerge was measured using a power meter.

Meanwhile, the respective end faces of the optical fiber on the incident side and the optical fiber on the emerging side were brought into contact with each other to measure, using the power meter, the power (P0) of the light in a state where no optical waveguides were present.

The initial optical loss caused by the optical waveguide (i.e., optical waveguide loss) was calculated by the equation “optical waveguide loss=−10×log (P1/P0).” The results are shown, along with the core dry film used, in the following Table 2.

TABLE 2

| | Example 5 | Example 6 |
|---|---|---|
| Core dry film | Example 2 | Example 4 |
| Dose (mJ/cm²) | 1000 | 300 |
| Initial waveguide loss (dB/cm) | 0.081 | 0.12 |

### REFERENCE SIGNS LIST

1 Optical Waveguide Resin Composition Layer
2 Film Base Member
3 Protective Film
5 Board
9 Electric Circuit
10 Lower Cladding Layer
11 Core
12 Light Source
13 Upper Cladding Layer
15 Via Hole

1. A resin composition for use in optical waveguides, the resin composition containing an epoxy resin (A) and a photocuring agent (B),
the photocuring agent (B) including a borate (B-1) having a boron anion.

2. The resin composition of claim 1, wherein
the borate (B-1) has a boron anion expressed by RₐBF₄-a, where R is each independently a fluorinated hydrocarbon group and a is an integer equal to or greater than 0 and equal to or less than 4.

3. The resin composition of claim 1, wherein
the borate (B-1) has a boron anion expressed by (C₆F₅)₄B⁻.

4. The resin composition of claim 1, wherein
the borate (B-1) has a cation expressed by the following formula (1): 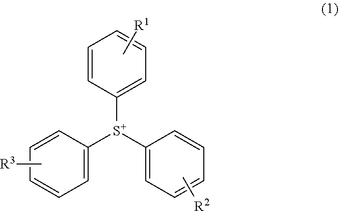
where R¹ is selected from the group consisting of a phenylthio group, a 4-biphenylylthio group, a 4-biphenoxy group, a 2-naphthylthio group, a 2-naphthoxy group, a 4-(4-acetyl)phenylthio group, and a 4-(4-benzoyl)phenylthio group; R² is selected from the group consisting of a 4-biphenylylthio group, a 4-biphenoxy group, a 2-naphthylthio group, a 2-naphthoxy group, and a hydrogen atom; and R³ is selected from the group consisting of a 4-biphenylylthio group, a 2-naphthylthio group, a methoxy group, a methyl group, a bromo group, a chloro group, and a hydrogen atom.

5. The resin composition of claim 1, wherein
content of the borate (B-1) is equal to or greater than 0.05 parts by mass and equal to or less than 0.8 parts by mass with respect to 100 parts by mass of the epoxy resin (A).

6. The resin composition of claim 1, wherein
the epoxy resin (A) includes at least one selected from the group consisting of a liquid aliphatic epoxy compound (A-1), a polyfunctional aromatic epoxy compound (A-2) having three or more epoxy groups in a molecule, and a solid bisphenol A epoxy compound (A-3).

7. The resin composition of claim 6, wherein
content of the liquid aliphatic epoxy compound (A-1) is equal to or greater than 10% by mass and equal to or less than 30% by mass with respect to an entire mass of the epoxy resin (A).

8. The resin composition of claim 6, wherein
content of the polyfunctional aromatic epoxy compound (A-2) is equal to or greater than 10% by mass and equal to or less than 60% by mass with respect to an entire mass of the epoxy resin (A).

9. The resin composition of claim 6, wherein
content of the solid bisphenol A epoxy compound (A-3) is equal to or greater than 10% by mass and equal to or less than 70% by mass with respect to an entire mass of the epoxy resin (A).

10. The resin composition of claim 1, further containing an antioxidant.

11. The resin composition of claim 1, wherein
proportion of epoxy groups included in the resin composition for optical waveguides which has been cured by irradiating the resin composition with a light ray having a wavelength of 365 nm at a dose of 1000 mJ/cm² and subjecting the resin composition to a heat treatment at 140° C. for 10 minutes to 100% of epoxy groups included in the resin composition for optical waveguides which has not been cured yet is equal to or less than 30%.

12. The resin composition of claim 11, wherein
an optical loss caused when light having a wavelength of 850 nm is allowed to pass through an optical waveguide along a longitudinal axis of the optical waveguide is equal to or less than 0.10 dB/cm, the optical waveguide being made of a cured product of the resin composition for optical waveguides and having a length of 50 mm, a thickness of 35 μm, and a width of 35 μm.

13. A dry film for use in optical waveguides, the dry film comprising a resin layer containing either the resin composition of claim 1 or a semi-cured product of the resin composition.

14. The dry film of claim 13, further comprising at least one film selected from the group consisting of a film base member and a protective film.

15. An optical waveguide comprising a core and a cladding layer that covers the core,
at least one of the core or the cladding layer containing a cured product of the resin composition of claim 1.
